(19) United States
(12) Patent Application Publication
(10) Pub. No.: US 2026/0139080 A1
(43) Pub. Date: May 21, 2026

(54) HYBRID SUPPORT FOR METALLOCENE CATALYST

(71) Applicant: KING FAHD UNIVERSITY OF PETROLEUM AND MINERALS, Dhahran (SA)

(72) Inventors: Mamdouh A. AL-HARTHI, Dhahran (SA); Farrukh SHEHZAD, Dhahran (SA); Hassam MAZHAR, Bihar (IN)

(73) Assignee: KING FAHD UNIVERSITY OF PETROLEUM AND MINERALS, Dhahran (SA)

(21) Appl. No.: 18/949,519

(22) Filed: Nov. 15, 2024

(51) Int. Cl. C08F 10/02; C07F 5/06

(52) U.S. Cl. CPC C08F 10/02; C07F 5/066

(57) ABSTRACT

A hybrid supported metallocene catalyst including a first layer based on hydroxide-functionalized hexagonal boron nitride, at least partially reacted with methylaluminoxane through an oxygen atom of hydroxyl groups of the hydroxide-functionalized hexagonal boron nitride. The hybrid support is in the form of layered nanosheets with a longest dimension of 50 to 500 nm.

### STATEMENT REGARDING PRIOR DISCLOSURE BY THE INVENTORS

Aspects of the present disclosure are described in Mazhar, H. et al., “Atomic Layer Deposition of γ-Al₂O₃ on Hexagonal Boron Nitride: A Hybrid Support for Metallocene Catalysts” published in Volume 9, Issue 32, Chemistry Select, which is incorporated herein by reference in its entirety.

### STATEMENT OF ACKNOWLEDGEMENT

Support provided by the Interdisciplinary Research Center, King Fahd University of Petroleum and Minerals, Saudi Arabia, through Project INRC2101 is gratefully acknowledged.

### BACKGROUND

### Technical Field

The present disclosure is directed to a hybrid support and, more particularly, towards a hybrid support based on an aluminum hydroxide-functionalized hexagonal boron nitride for metallocene catalysts.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Hexagonal boron nitride (hBN) is a two-dimensional layered material composed of a hexagonal arrangement of nitrogen atoms and boron atoms. The chemical structure of hBN provides several attractive properties, such as high thermal stability, chemical inertness, and a high dielectric constant. These characteristics make hBN a suitable material for various applications, such as optoelectronics, high-temperature electronic applications (such as power electronics), and thermoelectronics. In addition, properties such as the high dielectric constant and chemical inertness make hBN a suitable material for energy storage applications, such as supercapacitors and lithium-ion batteries. hBN can be used as a support material for catalysts due to its high thermal stability. For example, hBN has been used to improve the catalytic activity of metal catalysts such as platinum and gold by preventing poisoning or sintering. In addition to being used as a support material, hBN has been tested as a metal-free catalyst. hBN can act as a Lewis acid catalyst, promoting various chemical reactions like the Friedel-Crafts reaction and Diels-Alder reaction. hBN has also been used as a catalyst in organic synthesis and hydrogenation of unsaturated compounds. Furthermore, other catalytic applications of hBN related to energy storage include the hydrogen evolution reaction (HER) and the oxygen evolution reaction (OER) in water splitting. hBN can be functionalized by doping with metal ions (i.e., nickel, copper, and palladium), which have been seen to be effective catalysts for chemical reactions such as alcohol oxidation, water oxidation, and carbon dioxide reduction.

Applications of hBN can be further expanded by surface modification of the hBN. For example, by introducing various chemical groups, such as hydroxyl groups (—OH), onto the surface of hBN, its surface characteristics, such as wettability and biocompatibility, can be enhanced [Li, M. et al., Perspectives on environmental applications of hexagonal boron nitride nanomaterials, Nano Today, 2022, 44, 101486]. These modifications lead to new prospects for hBN in applications including biomedical, environmental, and energy storage. Methods, such as covalent functionalization by treating acids or other oxidizing agents, mechanical milling, hydrothermal treatment, and the like, exist for functionalizing hBN or similar materials. One route for surface modification of hBN with hydroxyl groups is through controlled air oxidation. This method negates solvents, acids, and harsh conditions, making it a mild and environmentally friendly synthesis approach.

Uses of hBN can be further enhanced by developing hybrid materials with other catalytically active materials. Although hBN-based hybrid materials have been developed in the past, there still exists a need to develop materials for catalytic applications. Accordingly, an object of the present disclosure to develop an hBN-based hybrid material as a support material for a metallocene catalyst for olefin polymerization that may overcome drawbacks of the current art.

### SUMMARY

In an exemplary embodiment, a hybrid support for a metallocene catalyst is described. The hybrid support has a first layer comprising a hydroxide-functionalized hexagonal boron nitride at least partially reacted with methylaluminoxane through an oxygen atom of hydroxyl groups of the hydroxide-functionalized hexagonal boron nitride. The hybrid support is in the form of layered nanosheets with a longest dimension of 50 to 500 nm.

In some embodiments, a method of making the hydroxide-functionalized hexagonal boron nitride is described. The method includes heating hexagonal boron nitride to a temperature of 800 to 1200° C. for 1 to 3 hours to form a material. The heating occurs at a rate of 8 to 12° C./minute in an air environment. The heating is followed by washing and separating the material and drying the material in a vacuum at 80 to 120° C. to form the hydroxide-functionalized hexagonal boron nitride.

In another exemplary embodiment, a method of making the hybrid support is described. The method includes mixing hydroxide-functionalized hexagonal boron nitride and methylaluminoxane in a nonpolar solvent for 2 to 4 hours at a temperature of 60 to 100° C. in an inert environment to form the support. This is followed by washing and filtering the hybrid support with the nonpolar solvent.

In some embodiments, one or more alumina groups are formed by a complete reaction of the methylaluminoxane with hydroxyl groups of the hydroxide-functionalized hexagonal boron nitride.

In some embodiments, one or more alumina groups are formed at edges of the layered nanosheets and at surface defects of the hydroxide-functionalized hexagonal boron nitride.

In some embodiments, units of tetraethyl orthosilicate react with methylaluminoxane and/or one or more oxygen-containing groups of the hydroxide-functionalized hexagonal boron nitride.

In some embodiments, the units of tetraethyl orthosilicate are deposited at boron-oxygen (B—O) sites in the hydroxide-functionalized hexagonal boron nitride.

In another exemplary embodiment, a method of making a hybrid support is disclosed. The method involves dissolving the hydroxide-functionalized hexagonal boron nitride in water to form a first solution, sonicating the first solution for 20 to 40 minutes, and adding alcohol to the first solution to form a second solution. The method further includes sonicating the second solution for 20 to 40 minutes, adding an ammonium solution, and a tetraethyl orthosilicate to the second solution to form a third solution. Further, the method includes sonicating the third solution for 20 to 40 minutes and then mixing the third solution for 20 to 30 hours. The product is separated from the third solution, washing and drying the product at 80 to 120° C. to form the hybrid support.

In some embodiments, a supported catalyst consists of the hybrid support and a bis(cyclopentadienyl)zirconium moiety.

In some embodiments, the supported catalyst is in the shape of layered sheets with a longest dimension of 50 to 300 nm, wherein the layered sheets have pores with a diameter of 0.5 to 10 nm.

In another exemplary embodiment, the method of making the supported catalyst is described. The method includes mixing the hybrid support and a bis(cyclopentadienyl) zirconium(IV) dichloride in a nonpolar solvent for 1 to 3 hours at a temperature of 50 to 70° C. to form the supported catalyst. This is followed by filtering, washing, and drying the supported catalyst.

In some embodiments, a method of olefin polymerization is disclosed. The method includes contacting the supported catalyst with an organic solvent to form a reaction mixture. This is followed by flowing a monomeric gas into the reaction mixture and adding a cocatalyst. The method further involves reacting the mixture for a time sufficient to form a polymerized product.

In some embodiments, the hybrid support has a ratio of surface hydroxyl groups to aluminum from 0.5:1 to 10:1.

In some embodiments, the polydispersity index of the product is from 6 to 25.

In some embodiments, the yield of the polymerized product is from 5.5 to 7.5 g.

In some embodiments, the molecular weight of the polymerized product is from 20,000 to 130,000 Mw.

In some embodiments, the polymerized product is a linear low-density polyethylene.

In some embodiments, the one or more alumina groups are gamma-Al₂O₃ (γ-Al₂O₃).

In some embodiments, in the hybrid support, boron-oxygen-oxygen-boron (B—O—O—B) sites in the hydroxide-functionalized hexagonal boron nitride do not react with the methylaluminoxane.

In some embodiments, the cocatalyst is a modified methylaluminoxane.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawing, wherein:

FIG. 1A is a flowchart of a method for making hydroxide-functionalized hexagonal boron nitride, according to certain embodiments.

FIG. 1B is a flowchart of a method for making a support, according to certain embodiments.

FIG. 1C is a flowchart of a method for making a hybrid support including the units of tetraethyl orthosilicate (TEOS) reacted with methylaluminoxane (MAO) and/or one or more oxygen-containing groups of the hydroxide-functionalized hexagonal boron nitride, according to certain embodiments.

FIG. 1D is a flowchart of a method of olefin polymerization, according to certain embodiments.

FIG. 2A is a thermogravimetric analysis (TGA) of hydroxide-functionalized hexagonal boron nitride (BNOH) and hybrids with alumina, according to certain embodiments.

FIG. 2B is a TGA of BNOH and hybrids with silica and alumina, according to certain embodiments.

FIG. 3 depicts Fourier-transform infrared (FTIR) spectra of hBN and hybrids, according to certain embodiments.

FIG. 4A depicts X-ray diffraction (XRD) patterns of hBN and hybrids, according to certain embodiments.

FIG. 4B depicts XRD patterns of hBN and hybrids, according to certain embodiments.

FIG. 4C depicts a transmission electron microscope (TEM) image of pristine hBN, according to certain embodiments.

FIG. 4D depicts a TEM image of BNOH, according to certain embodiments.

FIG. 4E depicts a TEM image of BNOH treated with modified methylaluminoxane (MAO) (designated as hBN/MAO and/or BNOH/MAO), according to certain embodiments.

FIG. 4F depicts a TEM image of a supported catalyst complex, referred to as hBN/MAO/Zr and/or BNOH/MAO/Zr (hBN/MAO treated with Zr catalyst), according to certain embodiments.

FIG. 4G depicts a TEM image of hBN/silica, according to certain embodiments.

FIG. 4H depicts a TEM image of hBN/silica/MAO, according to certain embodiments.

FIG. 5A depicts solid state ¹³C nuclear magnetic resonance (ssNMR) spectra of BNOH, BNOH/MAO, and BNOH/MAO/Zr, according to certain embodiments.

FIG. 5B is a bar graph depicting yield and molecular weight of a polymer sample with BNOH/MAO/Zr, according to certain embodiments.

FIG. 5C depicts molecular weight distribution of the polymer with BNOH/MAO/Zr, according to certain embodiments.

### DETAILED DESCRIPTION

In the following description, it is understood that other embodiments may be utilized, and structural and operational changes may be made without departure from the scope of the present embodiments disclosed herein.

When describing the present disclosure, the terms used are to be construed in accordance with the following definitions, unless a context dictates otherwise. Embodiments of the present disclosure will now be described more fully hereinafter with reference to the accompanying drawings wherever applicable, in which some, but not all embodiments of the disclosure are shown. In the drawings, reference numerals will be used to designate identical or corresponding parts throughout the several views. Further, as used herein, the words “a,” “an,” and the like generally carry a meaning of “one or more,” unless stated otherwise. Within the description of this disclosure, where a numerical limit or range is stated, the endpoints are included unless stated otherwise. Also, all values and subranges within a numerical limit or range are specifically included as if explicitly written out.

Furthermore, the terms “approximately,” “approximate,” “about,” and similar terms generally refer to ranges that include the identified value within a margin of 20%, 10%, or preferably 5%, and any values therebetween.

Embodiments of the present disclosure will now be described more fully hereinafter with reference to the accompanying drawings, in which some, but not all embodiments of the disclosure are shown.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, the term “compound” refers to a chemical entity, regardless of its phase-solid, liquid, or gaseous-as well as its state-crude mixture, purified, or isolated.

As used herein, the terms “particle size” may be thought of as the length or longest dimension of a particle. The greatest distance that can be measured from one point on a shape through its center to a point directly across from it is referred to as the “diameter” for a circle, oval, ellipse, and/or multilobe. Unless otherwise noted, the term “diameter” for polygonal shapes refers to the maximum length that can be measured between a polygon's vertex at the center of the face and its opposite vertex.

As used herein, the term “porosity” refers to a measure of the void or vacant spaces within a material.

As used herein, the term “pore size” may be thought of as the length or longest dimension of a pore opening.

As used herein, “nanoparticles” are particles having particle sizes of 1 nm to 500 nm within the scope of the present disclosure.

As used herein the term “deionized water” refers to the water that has (most of) the ions removed.

As used herein, the term “room temperature” refers to a temperature range of 25 degrees Celsius (° C.)±3° C. in the present disclosure.

As used herein, the term “ultrasonication” or “sonication” refers to a process in which sound waves are used to agitate particles in a solution.

As used herein, the term “filtration” refers to a mechanical or physical operation that can be employed for the separation of constituents of homogeneous or heterogeneous solutions.

As used herein, the term “catalyst” refers to a substance that speeds up a chemical reaction without being consumed in the process and remain unchanged after the reaction. Catalysts may react with one or more reactants to form intermediates that may subsequently give a reaction product and regenerate the catalyst in the process.

As used herein, the term “cocatalyst” refers to a substance that helps a primary catalyst work more efficiently in a chemical reaction.

As used herein, the term “supported catalyst” refers to a catalytic substance that is dispersed in and/or on a solid support material, which improves stability, dispersion, and reactivity of the catalytic substance in chemical reactions.

As used herein, the term “metallocene” refers to compounds in which cyclopentadienyl ligands are arranged in a sandwich-like structure around a transition metal (or a transition metal halide). The molecular structure of these compounds varies based on the type of ligand and the nature of the central metal.

As used herein, the term “hybrid support” refers to a type of support material used in catalytic processes or other chemical reactions that combine two or more different materials or functionalities. This hybrid material may enhance the performance of reactive systems by providing an amalgamation of beneficial properties.

As used herein, the term “monomers” refers to molecules that can undergo polymerization, thereby contributing constitutional repeating units to the structures of a macromolecule or polymer.

As used herein, the term “polymerization” refers to the process by which monomers combine end to end to form a polymer.

As used herein, the term “olefin polymerization” refers to a chemical process of creating polymers by linking together olefins (alkenes), such as ethylene or propylene.

As used herein, “polydispersity index (PDI)” refers to a measure of the distribution of molecular sizes in a polymer sample. A higher PDI indicates a greater range of sizes.

As used herein, the term “gel permeation chromatography (GPC)” refers to a technique used to separate molecules based on their size by passing them through a column filled with porous beads.

As used herein, the term “atomic layer deposition (ALD)” refers to a technique for depositing thin films one atomic layer at a time through sequential, self-limiting chemical reactions of gaseous precursors.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100 %.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium.

Aspects of the present disclosure are directed to a hybrid support. The hybrid support is used as a support for metallocene catalysts. The hybrid support is formed by atomic layer deposition (ALD) of alumina over hydroxide-functionalized hexagonal boron nitride. The supported catalyst complex exhibited good activity for generating ethylene-propylene polymers with up to 10 times higher molecular weight.

A hybrid support is described. The hybrid support includes a first layer, which comprises a hydroxide-functionalized hexagonal boron nitride (BNOH). The BNOH includes hydroxyl groups on the surface of hexagonal boron nitride (hBN). In some embodiments, other functional groups, such as amino (—NH₂), ether (—OR), amine (—NHR), acryl (—COR), alkyl (—R), ketone (═O), halogen (—X), a combination thereof, and the like, may be present on the surface of hBN. In some embodiments, the BNOH includes boron hydroxyl (B—OH) sites and boron-oxygen-oxygen-boron (B—O—O—B) sites. The BNOH is at least partially reacted with methylaluminoxane (MAO) through an oxygen atom of hydroxyl groups of the BNOH. The hybrid support is in the form of layered nanosheets with a longest dimension of 50 to 500 nm, preferably 100 to 400 nm, and preferably 200 to 300 nm.

In some embodiments, the hybrid support includes one or more alumina groups over the BNOH. In some embodiments, the alumina groups may be alpha-alumina (α-Al₂O₃), beta-alumina (β-Al₂O₃), gamma-alumina (γ-Al₂O₃), delta-alumina (δ-Al₂O₃), theta-alumina (θ-Al₂O₃), a combination thereof, and the like. In a preferred embodiment, the alumina group is γ-Al₂O₃. In some embodiments, a ratio of surface hydroxyl groups to aluminum is from 0.5:1 to 10:1, preferably 1:1 to 9:1, preferably 2:1 to 8:1, preferably 3:1 to 7:1, preferably 4:1 to 6:1. In some embodiments, the one or more alumina groups are deposited on the BNOH by a complete reaction of the MAO with hydroxyl groups of the BNOH. MAO is an organoaluminium compound with the approximate formula (Al(CH₃)O)ₙ. In some embodiments, other organoaluminum compounds, besides MAO, that are known to a person skilled in the art may also be used in place of or in combination with MAO. During the complete reaction of MAO with hydroxyl groups of the BNOH, the-OH group attached to the BNOH hydroxyl groups reacts, at least partially, with the methyl group of MAO (or the organic group if other organoaluminum compounds are used), to liberate methane/alkanes, thereby forming an oxygen-aluminum (—O—Al) bond. In some embodiments, the one or more alumina groups are formed at edges of the layered nanosheets and at surface defects of the BNOH. These edges have higher surface energy and diverse bonding features, making them more reactive for chemical interactions. In some embodiments, the Al groups are deposited only on the B—OH sites, and the B—O—O—B sites are unreacted/do not react with the MAO.

In some embodiments, the hybrid support includes one or more silica groups deposited on the BNOH. The silica groups are deposited by a reaction between a silica precursor (for example, tertarethylorthoslicate (TEOS)) with the MAO and/or one or more oxygen-containing groups of the BNOH. In some embodiments, the units of TEOS are deposited at boron-oxygen (B—O) sites in the BNOH.

The hybrid support is in the form of layered nanosheets. In alternate embodiments, the hybrid support may be in the form of nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, mixtures thereof, and the like. In a preferred embodiment, the hybrid support is in the form of layered nanosheets. The layered nanosheets have a longest dimension of 50-500 nm, preferably 100-450 nm, preferably 150-400 nm, preferably 200-350 nm, and preferably 250-300 nm.

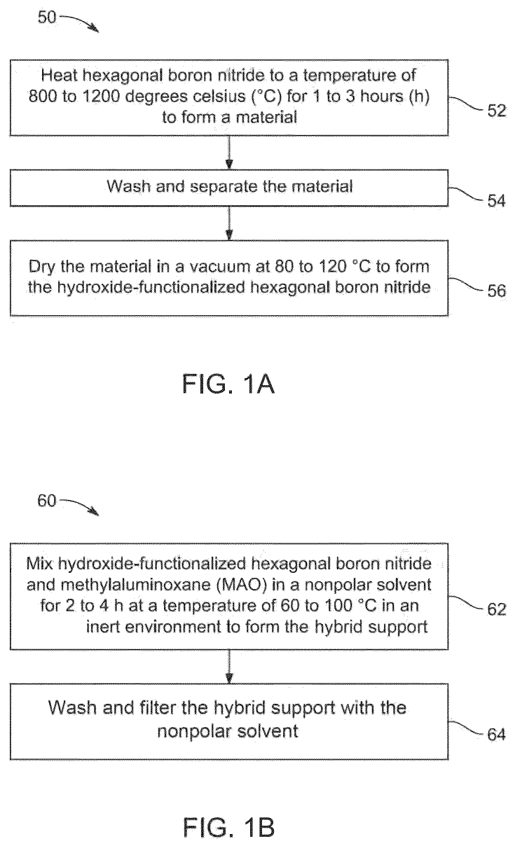

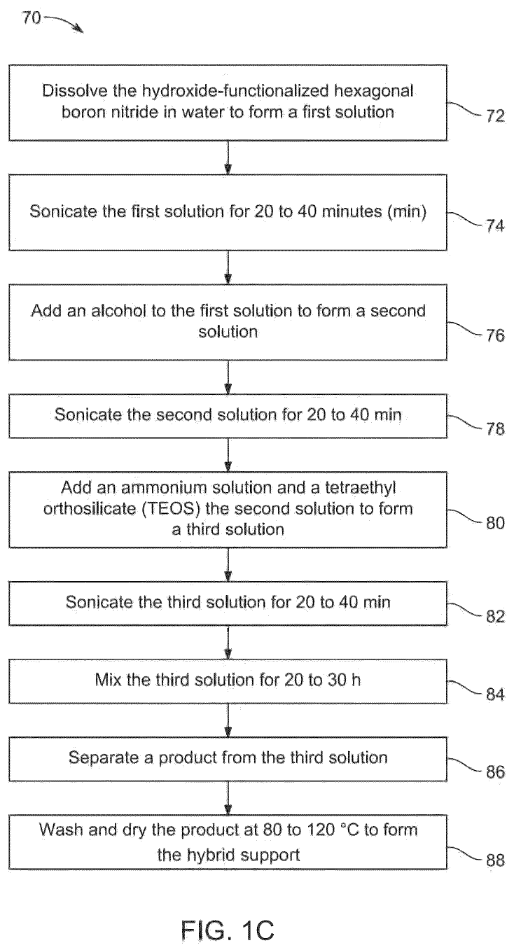

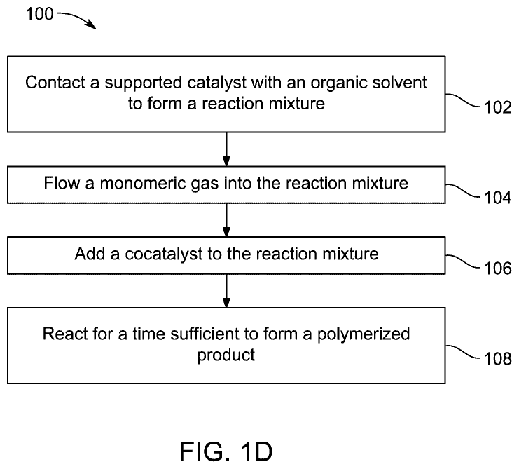

FIG. 1A illustrates a flowchart of a method 50 for making hydroxide-functionalized hexagonal boron nitride (BNOH). The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes heating hexagonal boron nitride (hBN) to a temperature of 800-1200° C., preferably 850-1150° C., preferably 900-1100° C., more preferably 950-1050° C., and yet more preferably about 1000° C. for 1-3 hours (h), preferably 1.5-2.5 h, and more preferably about 2 h, to form a material. In some embodiments, the hBN is heated at a rate of 8-12° C./minute (° C./min), preferably 9-11° C./min, and more preferably about 10° C./min. The hBN may be heated using heating appliances such as hot plates, muffle furnaces, tube furnaces, heating mantles ovens, microwaves, autoclaves and tapes, oil baths, salt baths, sand baths, air baths, hot-tube furnaces, hot-air guns, a combination thereof, and the like. In a preferred embodiment, the hBN is heated to a temperature of 1000° C. for 2 hours in a furnace, such as a quartz tube in a ceramic crucible (e.g., an alumina crucible) or other forms of containment. The furnace is preferably equipped with a temperature control system, which may provide a heating rate up to 50° C./min, preferably up to 40° C./min, preferably up to 30° C./min, preferably up to 20° C./min, or preferably up to 10° C./min. In a specific embodiment, the material is heated in the furnace at a rate of 10° C./min for 2 hours. In a preferred embodiment, the hBN is heated in an air environment, dry air or ambient air, to yield oxidized hexagonal boron nitride. The degree of oxidation and the density of hydroxyl groups on the surface can be controlled by adjusting the temperature and duration of the treatment process.

At step 54, the method 50 includes washing and separating the material. The material may be washed using a solvent like water, alcohol, and the like, and/or a mixture thereof. Suitable alcoholic solvents include methanol, ethanol, n-propanol, n-butanol, iso-butanol, isopropyl alcohol (IPA), a mixture thereof, and the like. The water may be tap water, distilled water, bi-distilled water, deionized water, deionized distilled water, reverse osmosis water, and/or some other water. The washed material may be separated via centrifugation; however, other suitable techniques for separation include internal and external filtration, natural and forced sedimentation, magnetic separation, vacuum filtration, vacuum distillation, chemical conversion, a combination thereof, and the like. In a preferred embodiment, the material is separated via centrifugation.

At step 54, the method 50 includes drying the material in a vacuum at 80-120° C., preferably 85-115° C., preferably 90-110° C., more preferably 95-105° C., and yet more preferably about 100° C. to form the BNOH. The material is preferably dried in a vacuum to prevent further oxidation of the hydroxide-functionalized hexagonal boron nitride. In alternate embodiments, drying may be done by using heating appliances such as hot plates, heating mantles ovens, microwaves, autoclaves, tapes, oil baths, salt baths, sand baths, air baths, hot-tube furnaces, hot-air guns a combination thereof, and the like. In some embodiments, the BNOH may be obtained by other methods known in the art, such as sonication in water.

FIG. 1B illustrates a flowchart of a method 60 of making the hybrid support. The order in which the method 60 is described is not intended to be construed as a limitation, and any number of the described method steps can be combined in any order to implement the method 60. Additionally, individual steps may be removed or skipped from the method 60 without departing from the spirit and scope of the present disclosure.

At step 62, the method 60 includes mixing BNOH and methylaluminoxane (MAO) in a nonpolar solvent for 2-4 h, preferably 2.5-3.5 h, and preferably about 3 h at a temperature of 60-100° C., preferably 62-98° C., preferably 64-96° C., preferably 66-94° C., preferably 68-92° C., preferably 70-90° C., preferably 72-88° C., preferably 74-86° C., preferably 76-84° C., more preferably 78-82° C., and yet more preferably about 80° C. in an inert environment to form the support. The amount of MAO to be mixed with the BNOH depends on the degree of hydroxyl groups present on the surface of the BNOH. The surface-activated BNOH reacts with MAO through ALD.

In a preferred embodiment, the BNOH and MAO are mixed in a nonpolar solvent for about 3 hours at a temperature of about 80° C. in an inert environment to form the support. In some embodiments, the inert environment may be provided by the flow of nitrogen, helium, argon, a mixture thereof, and the like. Suitable examples of non-polar solvents may include, but are not limited to, benzene, hexane, carbon tetrachloride, toluene, diethyl ether, chloroform, cyclohexane, heptane, octane, tetrachloroethylene, xylene, a mixture thereof, and the like. In a preferred embodiment, the non-polar solvent is anhydrous toluene. The mixing results in a reaction between alkyl groups of the MAO and hydroxyl groups of the BNOH, resulting in a deposition of the aluminum moieties over the BNOH. The reaction of the MAO was found to be selective, as the Al species were deposited only over the B—OH sites and the B—O—O—B sites remained unreacted.

At step 64, the method 60 includes washing and filtering the hybrid support with the nonpolar solvent. Suitable separation techniques include centrifugation, internal and external filtration, natural and forced sedimentation, magnetic separation, vacuum filtration, vacuum distillation, chemical conversion, a combination thereof, and the like. In a preferred embodiment, the non-polar solvent is anhydrous toluene.

FIG. 1C illustrates a flowchart of a method 70 of making the hybrid support including the units of tetraethyl orthosilicate (TEOS) reacted with the MAO and/or one or more oxygen-containing groups of the hydroxide-functionalized hexagonal boron nitride. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes dissolving the hydroxide-functionalized hexagonal boron nitride in water to form a first solution. The dissolution may be carried out manually, via stirring, and/or via sonication. The dissolution may be carried out until particles are fully dissolved in the solvent until a homogenous solution is obtained. The water may be tap water, distilled water, bi-distilled water, deionized water, deionized distilled water, reverse osmosis water, and/or some other water. In a preferred embodiment, the water is deionized water.

At step 74, the method 70 includes sonicating the first solution for 20-40 minutes (min), preferably 21-39 min, preferably 22-38 min, preferably 23-37 min, preferably 24-36 min, preferably 25-35 min, preferably 26-34 min, preferably 27-33 min, preferably 28-32 min, more preferably 29-31 min, and yet more preferably about 30 min. In a preferred embodiment, the first solution is sonicated for 30 minutes.

At step 76, the method 70 includes adding an alcohol to the first solution to form a second solution. Suitable examples of alcohol include, but are not limited to, methanol, ethanol, propanol, isopropanol, butanol, pentanol, hexanol, heptanol, octanol, nonanol, decanol, benzyl alcohol, cyclohexanol, glycerol, a combination thereof, and the like. In a preferred embodiment, the alcohol is ethanol.

At step 78, the method 70 includes sonicating the second solution for 20-40 min, preferably 21-39 min, preferably 22-38 min, preferably 23-37 min, preferably 24-36 min, preferably 25-35 min, preferably 26-34 min, preferably 27-33 min, preferably 28-32 min, more preferably 29-31 min, and yet more preferably about 30 min. In a preferred embodiment, the second solution is sonicated for 30 minutes.

At step 80, the method 70 includes adding an ammonium solution and a tetraethyl orthosilicate (TEOS) (a silica precursor) to the second solution to form a third solution. The ammonium solution is usually used as a catalyst or a pH-adjusting agent. In some embodiments, the ammonium solution may contain ammonium hydroxide (NH₄OH), ammonium chloride (NH₄Cl), and the like. TEOS acts as a source of silicon (silicon precursor); however, optionally, other silicon precursors such as, 3-triethoxysilylpropylamine, bis(trimethoxysilylpropylthioethenyl)benzene (BTB), and the like may be used in combination with or in place of TEOS. The third solution contains silica or silicate particles dispersed in a liquid.

At step 82, the method 70 includes sonicating the third solution for 20-40 min, preferably 21-39 min, preferably 22-38 min, preferably 23-37 min, preferably 24-36 min, preferably 25-35 min, preferably 26-34 min, preferably 27-33 min, preferably 28-32 min, more preferably 29-31 min, and yet more preferably about. In a preferred embodiment, the third solution is sonicated for about 30 minutes.

At step 84, the method 70 includes mixing the third solution for 20-30 h, preferably 21-29 h, preferably 22-28 h, more preferably 23-27 h, and yet more preferably about 24-26 h. The mixing may be carried out manually or with the help of a stirrer. In a preferred embodiment, the third solution is mixed for about 24 hours.

At step 86, the method 70 includes separating a product from the third solution. Suitable separation techniques include centrifugation, internal and external filtration, natural and forced sedimentation, magnetic separation, vacuum filtration, vacuum distillation, chemical conversion, chromatography, decantation, and membrane separation. In a preferred embodiment, the production is separated from the third solution via centrifugation.

At step 88, the method 70 includes washing and drying the product at 80-120° C., preferably 85-115° C., preferably 90-110° C., more preferably 95-105° C., and yet more preferably about 100°C. to form the hybrid support. The washing may be done using a solvent like water, ethanol, a mixture thereof, and the like. The water may be tap water, distilled water, bi-distilled water, deionized water, deionized distilled water, reverse osmosis water, and/or some other water. In a preferred embodiment, the support is washed with deionized water and ethanol. The product is further dried using heating appliances such as ovens, vacuum ovens, microwaves, autoclaves, hot plates, heating mantles and tapes, oil baths, salt baths, sand baths, air baths, hot-tube furnaces, hot-air guns, a combination thereof, and the like, in a in a vacuum oven at 100° C.

In an embodiment, a supported catalyst is described. The supported catalyst includes the hybrid support and a bis(cyclopentadienyl)zirconium moiety. The supported catalyst is in the shape of layered sheets having a longest dimension of 50 to 300 nm, preferably 100 to 250 nm, and preferably 150 to 200 nm and wherein the layered sheets have pores with a diameter of 0.5 to 10 nm, preferably 1 to 9 nm, preferably 2 to 8 nm, preferably 3 to 7 nm, and preferably 4 to 6 nm.

A method is described to make the supported catalyst. The method includes mixing the hybrid support and a bis(cyclopentadienyl)zirconium(IV) dichloride (Cp₂ZrCl₂) in a nonpolar solvent for 1-3 h, preferably 1.5-2.5 h, and preferably 2 h at a temperature of 50-70° C., preferably 51-69° C., preferably 52-68° C., preferably 53-67° C., preferably 54-66° C., preferably 55-65° C., preferably 56-64° C., preferably 57-63° C., preferably 58-62° C., and preferably 59-61° C. to form the supported catalyst. The molar concentration of Cp₂ZrCl₂ is in the range of 0.01 to 0.5 mM, preferably 0.05 to 0.3 mM, more preferably 0.1 to 0.2 M, and yet more preferably about 0.124 mM. In a preferred embodiment, the method includes mixing the hybrid support and Cp₂ZrCl₂ in a nonpolar solvent for 2 h at a temperature of 60° C. to form the supported catalyst. Suitable examples of non-polar solvents include, but are not limited to, benzene, hexane, carbon tetrachloride, toluene, diethyl ether, chloroform, cyclohexane, heptane, octane, tetrachloroethylene, and xylene. In a preferred embodiment, the non-polar solvent is anhydrous toluene. The mixing may be carried out manually or with the help of a stirrer.

The method further includes filtering, washing, and drying the supported catalyst. Filtration may be done by centrifugation, gravity filtration, vacuum filtration, pressure filtration, membrane filtration, microfiltration, a combination thereof, and any other filtration method known in the art. The washing may be done using a solvent like water, ethanol, a mixture thereof, and the like. The water may be tap water, distilled water, bi-distilled water, deionized water, deionized distilled water, reverse osmosis water, and/or some other water. The drying may be done by using heating appliances such as ovens, vacuum ovens, microwaves, autoclaves, hot plates, heating mantles and tapes, oil baths, salt baths, sand baths, air baths, hot-tube furnaces, hot-air guns, a mixture thereof, and the like. In a preferred embodiment, the supported catalyst is dried using a vacuum oven.

FIG. 1D illustrates a flow chart of a method 100 of olefin polymerization. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes contacting the supported catalyst with an organic solvent to form a reaction mixture. Suitable examples of organic solvents include, but are not limited to, one or more of propane, butane, pentane, hexane, octane, decane, dodecane, cyclopentane, methylcyclopentane, cyclohexane, methylcyclohexane, benzene, toluene, xylene, dichloromethane, chloroethane, dichloroethane, chlorobenzene, mixtures thereof, and the like. These solvents may be used after being mixed at a predetermined ratio. In a preferred embodiment, the organic solvent is anhydrous toluene.

At step 104, the method 100 includes flowing a monomeric gas into the reaction mixture. Suitable examples of monomeric gases in olefin polymerization reactions include, but are not limited to, ethylene (C₂H₄), propylene (C₃H₆), butylene (C₄H₈), pentene (C₅H₁₀), hexene (C₆H₁₂), 1-octene (C₈H₁₆), 1-decene (C₁₀H₂₀), mixtures thereof, and the like. The monomeric gas flows into the reaction mixture at a pressure of 5-15 pounds per square inch (psi), preferably 6-14 psi, preferably 7-13 psi, preferably 8-12 psi, more preferably 9-11 psi, and yet more preferably about 10 psi. In a preferred embodiment, the monomeric gas flows into the reaction mixture at a pressure of 10 psi. In some embodiments, a polyolefin may be prepared via a liquid-phase polymerization, a slurry-phase polymerization, and/or a gas-phase polymerization. Each method of polymerization may have specific reaction conditions tailored to desired polymer properties. In liquid-or slurry-phase polymerizations, solvents or the olefin monomer itself can serve as the medium.

At step 106, the method 100 includes adding a cocatalyst to the reaction mixture. In an embodiment, the cocatalyst is modified MAO (MMAO). MAO is a complex of aluminum and methyl groups that enhances the activity of metallocene catalysts in processes like the polymerization of ethylene and propylene. MAO helps activate the main catalyst, improving the efficiency and control of the polymerization reaction. Cocatalysts are used in catalytic processes, such as olefin polymerization, hydrocracking, alkylation reactions, and silicone production. MAO is recognized for its ability to react with various surfaces, accrediting its Lewis acidic nature. The modified MAO, which is a precursor of alumina, is procured commercially. In some embodiments, the MMAO may be any modified MAO known in the art. In some embodiments, the modified MAO may be synthesized by hydrolyzing a mixture of iBu₃Al and Me₃Al. In an embodiment, the modified MAO has an aluminum content of about 5-15 wt. %, preferably 6-10 wt. %, and more preferably about 7 wt. %.

At step 108, the method 100 includes reacting for a time sufficient to form a polymerized product. The reaction may be carried out for 20-40 min, preferably 21-39 min, preferably 22-38 min, preferably 23-37 min, preferably 24-36 min, preferably 25-35 min, preferably 26-34 min, preferably 27-33 min, preferably 28-32 min, more preferably 29-31 min, and yet more preferably about 30 min. In a preferred embodiment, the reaction is carried out for 30 minutes to form the polymerized product.

In some embodiments, the method 100 includes adding an acidic methanol to the reaction mixture after the 30 minutes of reacting to terminate the reacting. In some embodiments, the polymerized product may be washed with one or more solvents for 30 to 60 minutes, preferably 35 to 55 minutes, more preferably 40 to 50 minutes, and yet more preferably about 45 minutes. In some embodiments, after the washing, the polymerized product may be filtered and dried.

Additionally, the polymerization reaction can be conducted in batch, semi-continuous, or continuous modes. The batch, semi-continuous, or continuous method may be used individually or in a combination of two or more thereof; for example, polymerization may be carried out in two or more steps with different reaction conditions.

In some embodiments, the polymerized product is a linear low-density polyethylene (LDPE). In some embodiments, the PDI of the product is from 6-25, preferably 7-24, preferably 8-23, preferably 10-22, preferably 11-21, preferably 12-20, preferably 13-19, preferably 14-18, and preferably 15-17. In some embodiments, the yield of the polymerized product is from 5.5-7.5 g, preferably 6-7 g, and more preferably about 6.5 g. In some embodiments, the molecular weight of the polymerized product is from 20,000-130,000 Mw, preferably 30,000-120,000 Mw, preferably 40,000-110,000 Mw, preferably 50,000-100,000 Mw, preferably 60,000-90,000 Mw, and preferably 70,000-80,000 Mw.

### EXAMPLES

The following examples demonstrate a hybrid support for a metallocene catalyst having a first layer comprising a hydroxide-functionalized hexagonal boron nitride at least partially reacted with methylaluminoxane through an oxygen atom of hydroxyl groups of the hydroxide-functionalized hexagonal boron nitride. The hybrid support is in the form of layered nanosheets with a longest dimension of 50 to 500 nm. The examples are provided solely for illustration and are not to be construed as limitations of the present disclosure, as many variations are possible without departing from the spirit and scope of the present disclosure.

### Example 1: Chemical Reagents

Hexagonal boron nitride (hBN), modified methylaluminoxane (MAO-7 weight % aluminum), tetraethyleorthosilicate (TEOS), bis(cyclopentadienyl)zirconium(IV) dichloride (Cp₂ZrCl₂), ethanol, and anhydrous toluene, were all obtained commercially and used without further purification.

### Example 2: Thermal Oxidation of hBN

The OH functionalization of hBN was performed using a methodology similar to that reported in the literature [Cui, Z. et al., Large Scale Thermal Exfoliation and Functionalization of Boron Nitride, Small, 2014, 10, 2352-2355, which is incorporated herein by reference in its entirety]. A specific amount of hBN was heated at 1000° C. with a heating rate of 10° C./min for 2 hours in a quartz tube furnace in an air environment. The material was washed, centrifuged, and vacuum-dried at 100° C. to obtain OH functionalized hBN.

### Example 3: Atomic Layer Deposition (ALD) of Al and Si

Based on the hBN surface hydroxyl to Al ratio, a specific volume of MAO was injected into 1000 mg of BNOH (hydroxide-functionalized hexagonal boron nitride) along with 50 mL of anhydrous toluene inside the glovebox. The reaction mixture was stirred for 3 hours at 80° C. The alkyl group attached to the MAO reacts with the hydroxyl group of the BN sheet, resulting in the deposition of the aluminum moieties over the BN sheets. The product was washed with anhydrous toluene twice and filtered off to afford BN/Al. The silica precursor TEOS was used to decorate the silica layer on the BN sheets. The methodology was similar to that reported for silica decoration over graphene oxide [Shankar, R. et al., Enhanced Hydrolytic Stability of Porous Boron Nitride via the Control of Crystallinity, Porosity, and Chemical Composition, J. Phys. Chem. C., 2019, 123, 4282-4290, which is incorporated herein by reference in its entirety]. Approximately 0.06 g of BNOH were dissolved in 60 mL of deionized water, followed by sonication for 30 minutes. Then 120 mL of ethanol was added and further sonicated for 30 minutes. Now, along with 4 mL of ammonium solution, 0.6 mL of TEOS was added, mixed, and sonicated for half an hour, followed by 24 hours of stirring. The final mixture was centrifuged and washed twice with water and once with ethanol. The centrifugate was dried under a vacuum at 100° C. to obtain a BN—Si composite.

### Example 4: Catalyst Immobilization

200 mg of activated supports BN/Al and BN/Si/Al were added to 50 mL of anhydrous toluene; for this, 0.1241 mmol of Zr was added. The reaction mixture was stirred for 2 hours at 60° C. The product mixture was filtered and washed twice. The wet cake was dried under a vacuum to obtain supported catalysts, BN/Al/Zr and BN/Si/Al.

### Example 5: Polymerization

The polymerization reaction was carried out in a Schlenk flask reactor. The supported catalyst corresponding to 0.01241 mmol of Cp₂ZrCl₂ was transferred to the reactor with 80 mL of anhydrous toluene. The reactor was connected to the monomer gas supply maintained at 10 psi. After gas saturation in the solvent, cocatalyst MMAO was added to begin polymerization. After 30 minutes of the reaction, the polymerization was terminated with acidic methanol. After 45 minutes of washing, the polymer was filtered off and dried to obtain the polymer.

### Example 6: Thermal Analysis

Thermal analysis of nanomaterials and polymers was performed using a thermogravimetric analysis machine (TGA) (TA SDTQ 600). About 7 mg of sample was loaded into the TGA sample holder and heated to a certain temperature in a nitrogen (or oxygen) environment at a ramp rate of 20° C./min.

### Example 7: Atomic Layer Deposition

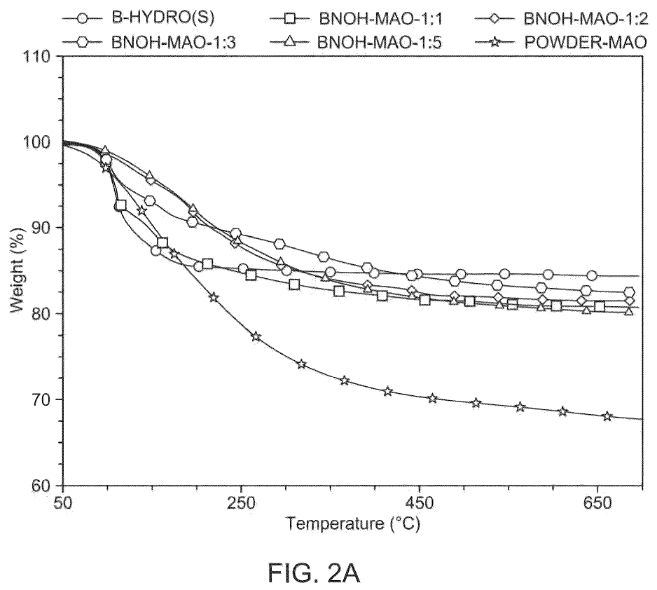

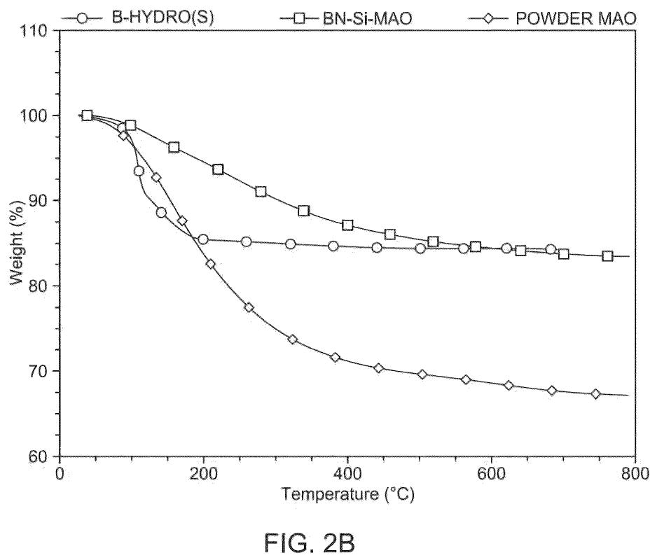

Thermal analysis of hBN and their hybrids were analyzed using thermogravimetric analysis (TGA). hBN was heated to 1000° C. in the presence of air. Oxidation initiated in a temperature range of 900-1000° C. resulted in 120 percent oxidation weight gain. The oxidized hBN was washed and dried to produce a functionalized hBN, i.e., BNOH. FIG. 2A shows the TGA curve of functionalized hBN and hybrids. BNOH exhibits a maximum weight loss in the temperature range of 50 to 200° C., primarily associated with water loss and the surface hydroxyl group of BNOH. Furthermore, the MAO treatment of BNOH led to a surface reaction of hydroxyl groups with MAO, which caused a loss of hydroxyl groups on the surface. The BNOH-MAO hybrids were thermally more stable than BNOH. Stability of the BNOH-MAO hybrids increased with an increase in aluminum. Moreover, the hybrid of BNOH—Si-MAO was also thermally more stable than that of the BNOH substrate. The enhanced stability is linked to the absence of surface hydroxyl due to their reaction with TEOS (FIG. 2B).

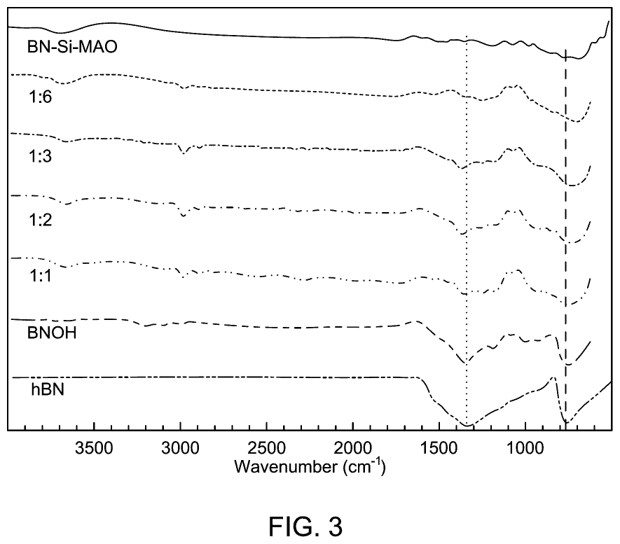

FTIR spectroscopy (FIG. 3) examined the functional groups introduced into the pristine hBN. The adsorption peaks at 1338-1376 cm⁻¹ and 755 cm⁻¹ correspond to the B—N in-plane stretching vibration and the B—N—B out-of-plane bending vibration, respectively. New peaks appeared in the BNOH sample, which can be attributed to B—OH bands (3200 cm⁻¹, 1000 cm⁻¹), B—O bands (1190 cm⁻¹, 925 cm⁻¹), and O—B—O bands (551 cm⁻¹).

During reactions of BNOH and MAO, hydroxyl groups (—OH) on the surface of BNOH react with alkyl groups of MAO to liberate alkanes and form —O—Al bonds on the surface of BNOH. This assumption is supported by the FTIR spectra of the BNOH-MOA, which demonstrate the absence of peaks related to the B—OH (3200 cm⁻¹, 1000 cm⁻¹). New peaks appear at 2977 cm⁻¹ and 2888 cm⁻¹, which are related to the stretching vibration of the alkyl group presences and the peak of the Al—CH₃ deformation mode at 1257 cm⁻¹. The peak at 933 cm⁻¹ corresponds to Al—O bonds. B—O and O—B—O present in BNOH do not react with MAO and are represented by the peaks at 1176 cm¹ and 1080cm⁻¹.

FTIR spectra corresponding to the BNOH—Si-MAO reveal that the silica precursor TEOS

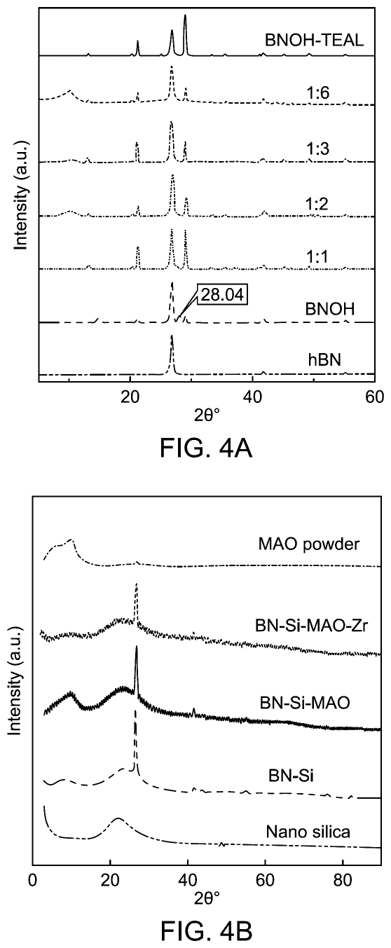

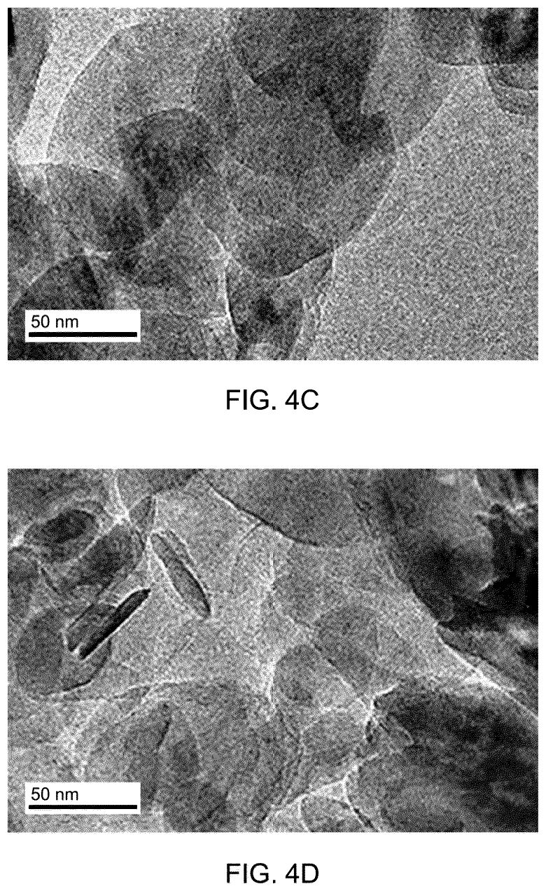

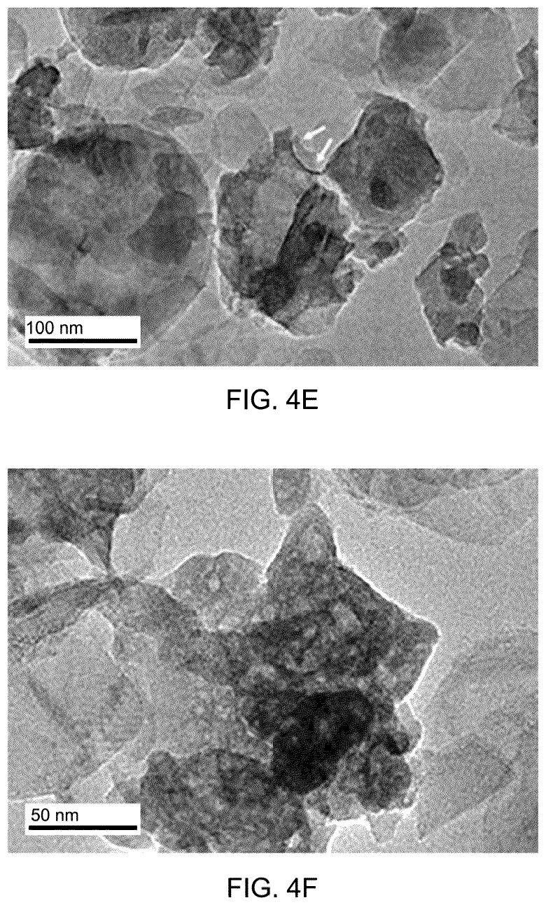

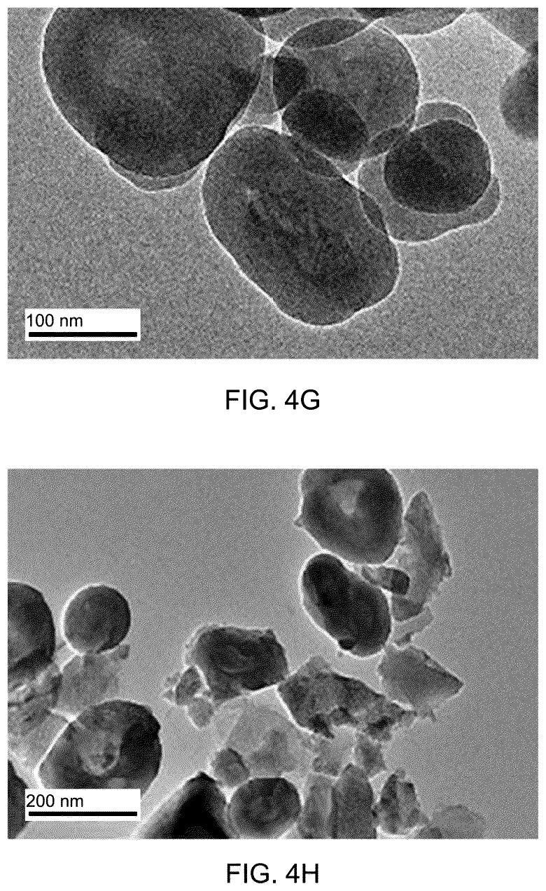

consumes all the —OH and B—O sites present on the hBN surface. The new peak evident in the FTIR spectra at 3676 cm⁻¹ is interpreted as the superimposition of the silanol group and —OH group of alumina. The band at 1492 cm⁻¹ is assigned to the asymmetric deformation mode of the methyl group. The absorption band at 690 cm⁻¹ indicates Si—O—Al. XRD spectra of the samples show a characteristic peak of 002 planes of hBN at 26.8 degrees. New peaks for BNOH appeared at 28.02 and 29 degrees, which could be attributed to the attached boric acid and B₂O₃. Furthermore, the alkyl aluminum treatment of the BNOH consumed all —OH groups present at the surface, resulting in the disappearance of the boric acid peak. The XRD peak corresponding to B₂O₃ was retained, indicating their inertness toward reaction with the alkyl aluminum species (FIG. 4A). MAO was used in different ratios, and the B₂O₃ linked to the hBN sheet was inert. The peak at 10 degrees is related to the alkyl aluminum attached to the hBN nanosheets. A new peak at 13 degrees is attributed to the less crystalline γ-AlOOH presence. The results of XRD support the FTIR spectra. The silica precursor was reactive to both boric acid and B₂O₃ sites, as demonstrated by the XRD spectra (FIG. 4B).

Surface morphology of the hybrid materials was analyzed by transmission electron microscopy (TEM) imaging (FIG. 4C-FIG. 4H). hBN was present as a two-dimensional stacked sheets with smooth edges (FIG. 4C). Thermal exfoliation of the hBN lead to surface and edge etching caused by oxidation. Oxidation led to defects on the surface of the hBN, where oxygen atoms tend to embed into those defects. This process causes an increase in spacing and the formation of dislocations. As oxidation progresses, more oxygen atoms are introduced, increasing surface stress (FIG. 4D).

MAO treatment of hydroxyl functionalized hBN caused chemical adsorption of aluminum species over the substrate, forming Al—O bonds with the surface. The nucleation of the layer of aluminum species on the substrate is competitive and could be continuous or semicontinuous. The molecular/atomic layer deposition of AlOOH at the edges and over the surfaces is shown in FIG. 4E (arrows). Considering the chemical inertness of the hBN, the surface chemistry could occur only at the edges and surface defects (FIG. 4E).

The BNOH surface, with the abundant presence of oxygen in different forms of surface oxides, as demonstrated by FTIR spectroscopy and XRD, was reactive toward the silica precursor TEOS. The surface coverage was observed at the edges, forming a sandwich of hBN and silica, while the interior surface remained in the form of hBN. Furthermore, the alkyl-aluminum treatment of the hBN/Si hybrid showed deposition of the alumina layer.

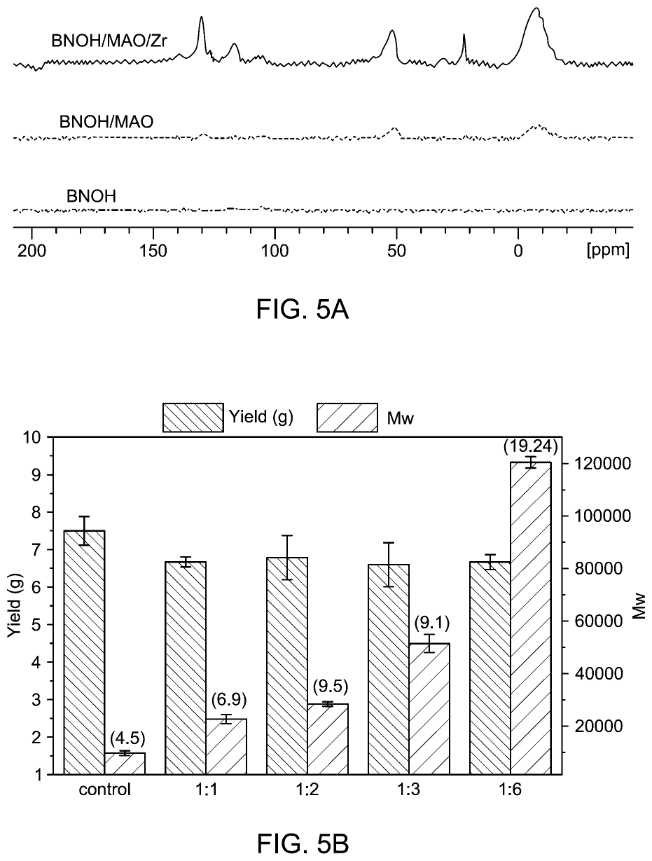

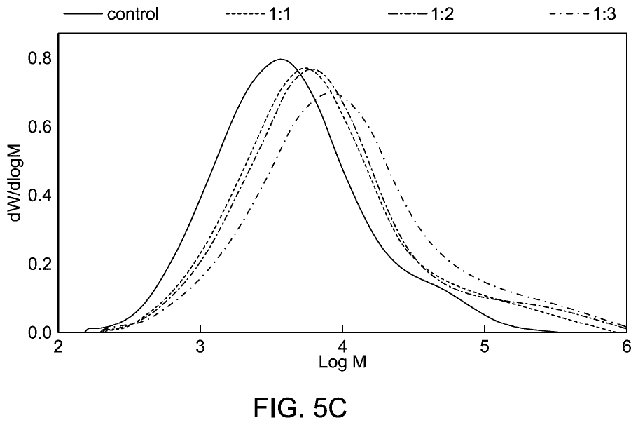

The surface-activated hBN through atomic layer deposition of MAO was utilized to support metallocene catalysts through an ion-pairing mechanism. The activated support and the supported catalyst complex were characterized by ¹³C solid-state (ss) MAS NMR (FIG. 5A). The hBN/MAO showed signals δ at −9 and 50.9 ppm, which were related to the MAO. Furthermore, supporting Cp₂ZrCl₂ over the hBN/MAO caused a maximum shift of MAO to −7 and 52.1 ppm. An additional peak appeared at 129 ppm that was related to the Cp ring of the catalyst. The coordination mode (tetrahedral and octahedral) of the Al atom (δ=7-80) in MAO was confirmed by ²⁷Al ssNMR.

The —OH deposited hBN atomic layers were utilized as a support to immobilize the homogeneous Cp₂ZrCl₂ (Zr) catalyst for efficient polymerization. Hybrid hBN/Al supports with different surface hydroxyl to aluminum rations (O:Al=1, 2, 3, and 6) were synthesized for the heterogenization of the molecular catalyst. The supported catalyst complexes hBN/Al/Zr were tested for their catalytic polymerization activity and were highly active (FIG. 5B and FIG. 5C). The linear low-density polyethylene (LLDPE) yield corresponding to the solution phase polymerization was 7.5 g. The molecular weight (Mw) and polydispersity index (PDI) of the control sample were 10020 Mw and 4.5, respectively. The molar equivalent of the supported catalyst having an O-to-Al ratio of 1:1 demonstrated a slight drop in the activity; however, the values for Mw and PDI increased. An increase in the O to Al ratio of the hBN/MAO support had no impact on the catalytic activity; however, this increase in the ratio affected the polymer microstructure and showed a gradual increase in the molecular weight and PDI. The production of higher molecular weight polymers could be attributed to the increased strength of the supported active sites. The high PDI of the produced polymers is related to intrinsic low-pressure reaction conditions that cause limitations in mass transfer. Polymers with high PDI offer ease in processing and are desired for multiple applications. Reduction in the activity of supported catalyst complexes could be related to a mass transfer limitation.

The present method discloses a facile methodology for ALD of alumina and silica over hydroxylated hBN. The alumina was deposited only at the B—OH sites, while the B—O—O—B sites remained unaffected, irrespective of the MAO concentration. TEOS treatment of the hBN surface resulted in Si-species deposition at all B—O sites. hBN/γ-Al₂O₃ was used to support a metallocene catalyst to polymerize a slurry phase of ethylene and propylene. The supported catalyst complex was highly active and a hBN: γ-Al₂O₃ ratio of 1:6 produced polymer with 10 times higher molecular weight (Mw) than the corresponding polymer produced by solution phase polymerization.

Numerous modifications and variations of the present disclosure are possible in light of the above teachings. Therefore, it is to be understood that within the scope of the appended claims, the disclosure may be practiced other than as specifically described herein.

1: A hybrid support, comprising:
a first layer comprising a hydroxide-functionalized hexagonal boron nitride at least partially reacted with methylaluminoxane through an oxygen atom of hydroxyl groups of the hydroxide-functionalized hexagonal boron nitride,
wherein the hybrid support is in the form of layered nanosheets with a longest dimension of to 500 nm.

2: The hybrid support of claim 1, wherein the hydroxide-functionalized hexagonal boron nitride is made by a process comprising:
heating hexagonal boron nitride to a temperature of 800 to 1200° C. for 1 to 3 hours to form a material,
wherein the heating occurs at a rate of 8 to 12° C. /minute,
wherein the heating occurs in an air environment,
washing and separating the material; and
drying the material in a vacuum at 80 to 120° C. to form the hydroxide-functionalized hexagonal boron nitride.

3: The hybrid support of claim 1, wherein the hybrid support is made by a process comprising:
mixing hydroxide-functionalized hexagonal boron nitride and methylaluminoxane in a nonpolar solvent for 2 to 4 hours at a temperature of 60 to 100° C. in an inert environment to form the support; and
washing and filtering the hybrid support with the nonpolar solvent.

4: The hybrid support of claim 1, further comprising one or more alumina groups formed by complete reaction of the methylaluminoxane with hydroxyl groups of the hydroxide-functionalized hexagonal boron nitride.

5: The hybrid support of claim 4, wherein the one or more alumina groups are formed at edges of the layered nanosheets and at surface defects of the hydroxide-functionalized hexagonal boron nitride.

6: The hybrid support of claim 1, further comprising:
units of tetraethyl orthosilicate reacted with the methylaluminoxane and/or one or more oxygen-containing groups of the hydroxide-functionalized hexagonal boron nitride.

7: The hybrid support of claim 6, wherein the units of tetraethyl orthosilicate are deposited at boron-oxygen (B—O) sites in the hydroxide-functionalized hexagonal boron nitride.

8: The hybrid support of claim 6, wherein the hybrid support is made by a process comprising:
dissolving the hydroxide-functionalized hexagonal boron nitride in water to form a first solution;
sonicating the first solution for 20 to 40 minutes;
adding an alcohol to the first solution to form a second solution;
sonicating the second solution for 20 to 40 minutes;
adding an ammonium solution and a tetraethyl orthosilicate to the second solution to form a third solution;
sonicating the third solution for 20 to 40 minutes;
mixing the third solution for 20 to 30 hours;
separating a product from the third solution; and
washing and drying the product at 80 to 120° C. to form the hybrid support.

9: A supported catalyst, comprising:
the hybrid support of claim 1; and
a bis(cyclopentadienyl)zirconium moiety.

10: The supported catalyst of claim 9, wherein the supported catalyst is in the shape of layered sheets having a longest dimension of 50 to 300 nm and wherein the layered sheets have pores with a diameter of 0.5 to 10 nm.

11: The supported catalyst of claim 9, wherein the supported catalyst is made by a process comprising:
mixing the hybrid support and a bis(cyclopentadienyl)zirconium(IV) dichloride in a nonpolar solvent for 1-3 hours at a temperature of 50 to 70° C. to form the supported catalyst; and
filtering, washing, and drying the supported catalyst.

12: A method of olefin polymerization, comprising:
contacting the supported catalyst of claim 9 with an organic solvent to form a reaction mixture;
flowing a monomeric gas into the reaction mixture;
adding a cocatalyst to the reaction mixture; and
reacting for a time sufficient to form a polymerized product.

13: The hybrid support of claim 1, wherein a ratio of surface hydroxyl groups to aluminum is from 0.5:1 to 10:1.

14: The method of claim 12, wherein a polydispersity index of the product is from 6 to 25.

15: The method of claim 12, wherein a yield of the polymerized product is from 5.5 to 7.5 g.

16: The method of claim 12, wherein a molecular weight of the polymerized product is from 20,000 to 130,000 Mw.

17: The method of claim 12, wherein the polymerized product is a linear low-density polyethylene.

18: The hybrid support of claim 5, wherein the one or more alumina groups are gamma-Al₂O₃, γ-Al₂O₃.

19: The hybrid support of claim 1, wherein boron-oxygen-oxygen-boron (B—O—O—B) sites in the hydroxide-functionalized hexagonal boron nitride do not react with the methylaluminoxane.

20: The method of claim 12, wherein the cocatalyst is a modified methylaluminoxane.
